(19) United States
(12) Patent Application Publication
(10) Pub. No.: US 2008/0151765 A1
(43) Pub. Date: Jun. 26, 2008

(54) Enhanced Jitter Buffer

(76) Inventor: Sanal Chandran Cheruvathery, Bangalore (IN)

Correspondence Address: Ryan, Mason & Lewis, LLP, 90 Forest Avenue, Locust Valley, NY, 11560, US

(21) Appl. No.: 11/613,535

(22) Filed: Dec. 20, 2006

(51) Int. Cl. H04J 1/16

(52) U.S. Cl. 370/252; 370/230

(57) ABSTRACT

A jitter buffer having a controllable delay associated therewith includes at least one ring buffer. The ring buffer includes a plurality of storage elements therein and is configured having independent read and write operations. The delay associated with the jitter buffer is controllable as a function of the number of elements between a first element accessed by the write operation and a second element accessed by the read operation. The minimum number of elements in the ring buffer may be determined as a function of the maximum acceptable jitter divided by the size of a data frame to be stored in the ring buffer.

### FIELD OF INVENTION

The present invention relates generally to buffer design, and more particularly relates to techniques for an improved adaptive jitter buffer.

### BACKGROUND OF THE INVENTION

Jitter is a variation in packet transit delay caused by queuing, contention and serialization effects on the path through the network. In general, higher levels of jitter are more likely to occur on either slow or heavily congested links. A jitter buffer is designed to remove the effects of jitter from the decoded network stream by buffering each arriving packet for a short interval before outputting the packets in the order they were sent rather than the order they were received. Jitter buffers are most commonly used to provide quality of service (QoS) for real-time protocol (RTP) transmissions, such as, for example, voice over internet protocol (VoIP) telephony.

If the jitter buffer is either too large or too small, it imposes unnecessary constraints on the characteristics of the network. An oversized jitter buffer adds to the end-to-end delay, meaning that less delay budget is available for the network; hence, the network needs to support a tighter delay target than is practically necessary. If a jitter buffer is too small to accommodate the network jitter, buffer underflows or overflows can occur. In an underflow, the buffer is empty when the codec (coder-decoder or compression/decompression module) needs to play out a sample. This is handled through the use of packet loss concealment (PLC) packets, as is well-known in the art, which may result in degraded quality. In an overflow, the jitter buffer is already full and another packet arrives; that next packet cannot be enqueued in the jitter buffer and, in conventional methodologies, is discarded. Thus, both jitter buffer underflows and overflows cause undesirable voice quality degradation.

Jitter buffers may be fixed or adaptive (e.g., variable) in size. A fixed jitter buffer maintains a constant size whereas an adaptive jitter buffer has the capability of adjusting its size dynamically in order to optimize the delay/discard tradeoff. Current adaptive jitter buffer algorithms seek to maximize performance on the network design by increasing the jitter buffer size to the current measured jitter value following a jitter buffer overflow, slowly decreasing the jitter buffer size when the measured jitter is less than the current jitter buffer size, and interpolating for the loss of a packet on a jitter buffer underflow. However, conventional methodologies still drop packets in order to produce this fixed delay.

Accordingly, there exists a need for a jitter buffer architecture which does not suffer from one or more of the above-noted problems associated with conventional jitter buffer design methodologies.

### SUMMARY OF THE INVENTION

In the accordance with the aforementioned need, the present invention, in illustrative embodiments thereof, comprises a jitter buffer which will not drop packets. The jitter buffer preferably includes a ring buffer having a fixed number of storage elements and is arranged such that a delay introduced by the jitter buffer is adaptively controlled based on the number of elements by which a read operation lags behind a write operation of the ring buffer.

In accordance with one aspect of the present invention, a jitter buffer having a controllable delay associated therewith includes at least one ring buffer. The ring buffer includes a plurality of storage elements and is configured having independent read and write operations. The delay associated with the jitter buffer is controllable as a function of the number of elements between a first element accessed by the write operation and a second element accessed by the read operation. The minimum number of elements in the ring buffer may be determined as a function of the maximum acceptable jitter divided by the size of a data frame to be stored in the ring buffer. Additionally, at least one element in the ring buffer may reside in one of multiple logical states, such as Ready, Late, Hit, and Miss.

In accordance with another embodiment of the present invention, a method of buffering data includes the steps of writing at least one data packet from an input data stream into a first storage element of a ring buffer including multiple storage elements, reading data from a second element of the ring buffer, and controlling a delay between when the data packet is received from the input data stream and when the data packet is output by the ring buffer by selectively controlling the number of elements between the second element accessed by the reading step and the first element accessed by the writing step.

In accordance with a third embodiment of the invention, an article of manufacture includes a machine-readable storage medium containing one or more software programs that, when executed, perform the steps of: writing at least one data packet from an input data stream into a first storage element of a ring buffer including multiple storage elements; reading data from a second storage element of the ring buffer; and controlling a delay between when the data packet is received from the input data stream and when the data packet is output by the ring buffer by selectively controlling the number of elements between the second element accessed by the reading step and the first element accessed by the writing step.

These and other features, objects and advantages of the present invention will become apparent from the following detailed description of illustrative embodiments thereof, which is to read in connection with the accompanying drawings.

### BRIEF DESCRIPTION OF THE DRAWINGS

FIG. 1 is a diagram showing an exemplary buffer layout in accordance with an aspect of the present invention.

FIG. 2 is a state transition diagram which illustrates the operation of the read and write processes, according to an aspect of the invention.

FIG. 3 is a block diagram depicting an exemplary processing system in which techniques of the present invention may be implemented, in accordance with an embodiment of the invention.

### DETAILED DESCRIPTION OF THE INVENTION

The present invention will be described herein in the context of exemplary methods and apparatus for an improved adaptive jitter buffer. It is to be understood, however, that the techniques of the present invention are not limited to the methods and apparatus shown and described herein. Rather, the invention is more generally applicable to buffers and similar data structures generally. While specific steps may be described herein for implementing buffering methodologies in accordance with embodiments of the invention, it is to be appreciated that these steps are merely illustrative, and that various other steps for performing similar functions are contemplated, as will become apparent to those skilled in the art.

FIG. 1 is a diagram showing an exemplary buffer layout in accordance with an aspect of the present invention. As apparent from the figure, the exemplary buffer preferably comprises a ring buffer 100 including at least one storage element 110. Each element 110 in the ring buffer preferably comprises a data array on which a media data frame will be stored. Optimally, ring buffer 100 is of a fixed size, which may be determined by dividing the maximum acceptable jitter by the data frame size. The minimum number of elements, N_{b}, in the ring buffer 100 may therefore be expressed as:

$${N}_{b} = \frac{{J}_{m}}{{F}_{s}} ,$$

where Jₘ represents maximum acceptable jitter and Fₛ represents the data frame size, both in the same units of time (e.g., milliseconds (ms)). For a VoIP application, for example, the maximum acceptable jitter may be 150 ms, based on the International Telecommunication Union (ITU) G.114 standard for one-way delay budget, and the data frame size may be 20 ms, based on the ITU G.711 and G.729 standards for default packetization rate, thus resulting in a preferred buffer size of 8, as shown in FIG. 1. It is to be understood, however, that the invention is not limited to a particular buffer size, nor is it limited to use with a particular data transmission standard.

In an illustrative embodiment of the invention, each element (e.g., 110) in the ring buffer 100 is associated with an index number, which may, for example, range from 0 to a maximum index number equal to a size of the buffer minus one. Each index number is preferably indicative of a corresponding temporal relationship with respect to packets of data in an input data stream supplied to the buffer, although alternative indexing schemes are similarly contemplated. The buffer elements are preferably arranged such that adjacent elements are assigned sequentially increasing (or decreasing) index numbers. In the illustrative ring buffer 100, which has a buffer size of 8, the index numbers preferably range from 0 to 7. For example, element 110 may have an index of 0. In that case, assuming that the elements are accessed in a clockwise manner and that sequentially increasing index numbers are employed, the element currently being processed by read operation (Read Task) 120 would have an index of 3 and the element currently being processed by write operation (Write Task) 130 would have an index of 7. The index numbers may be used to represent the respective positions of the elements within the ring buffer 100 relative to one another.

Each packet is preferably placed into the ring buffer 100 by a write operation as soon as it is received. A bucket sort, or alternative sorting methodlogy, may be employed to place a packet into the ring buffer 100. Specifically, a packet with a sequence number, S, is preferably placed into an index number, I, equal to the sequence number S of the packet modulo the buffer size, such that:

I=S%n_{b},

where n_{b} is the number of elements in the ring buffer and the symbol “%” represent a modulo operation. As previously stated, the buffer size n_{b} is preferably fixed as a function of the data frame size and the maximum acceptable jitter.

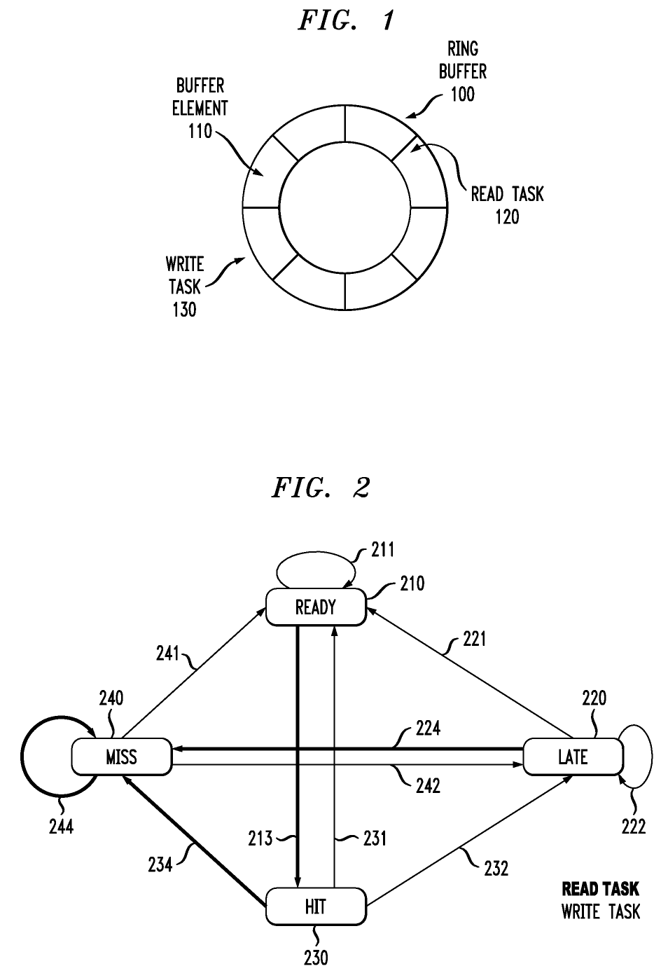

The read and write operations are performed independently of one another on different portions of the ring buffer 100; in other words, each read or write operation preferably processes an element at a different index number of the buffer at any given time. Each read or write operation sequentially accesses an element in order of increasing index number, which may be defined in a clockwise direction, at a substantially steady pace (determined by the frame size), returning to the zero index following the maximum index. Alternatively, each read or write operation may sequentially access an element in order of decreasing index number, which may be defined in a counter-clockwise direction, at a substantially steady pace, returning to the maximum index following the zero index. In either case, the read and write operations access the elements in the same direction (e.g., either both clockwise or both counter-clockwise). The operations performed by the read and write operations, as well as a state attribute associated with each element and used in conjunction with these operations, will be described in greater detail below with reference to FIG. 2.

The write operation 130 runs ahead of the read operation 120; the read operation should process elements which have already been processed by the write operation. The time lag between the read operation 120 and the write operation 130 (e.g., how many elements the read operation is behind the write operation) determines the delay introduced by the jitter buffer. This delay may be controlled by increasing or decreasing the number of elements between the read and write operations. For example, the jitter buffer delay may be decreased by advancing the read operation an additional one or more elements (e.g., skipping one or more frames) while halting the write operation. Similarly, the buffer delay may be increased by pausing the read operation (e.g., playing a PLC packet, which may be generated using essentially any algorithm known to those skilled in the art, instead of playing the next data packet) while advancing the write operation an additional one or more elements. Depending on the number of elements skipped or paused, the delay may be increased or decreased, respectively, by multiples of the frame size.

By way of example only, and without loss of generality, consider a ring buffer 100 having eight elements and having a frame size of 20 ms for each element. Assume the read operation 120 lags behind the write operation 130 by four elements, thereby introducing a buffer delay of about 80 ms. By skipping two elements, the read operation will lag behind the write operation by only two elements, thereby decreasing the delay to 40 ms. Likewise, by playing PLC packets instead of the next packet in the buffer while the write operation continues to advance two elements, the read operation will lag behind the write operation by six elements, thereby increasing the delay to 120 ms.

FIG. 2 is a state transition diagram which illustrates an exemplary operation of the read and write operations, according to an aspect of the invention. In an illustrative embodiment, each element in the ring buffer is associated with one of four possible states, namely, Ready 210, Late 220, Hit 230, or Miss 240. The Ready state 210 indicates that data is ready to be read from the corresponding element. The write operation marks the state of an element as Ready after a successful write operation has been completed. When the write operation is expecting a particular packet index i, and a packet with index i+k (k>0) is received, then the write operation marks indicies from i to i+k−1 as Late. The read operation marks an element as Read after a successful read operation. This occurs only if the previous state of the element was Ready 210. When the read operation finds an element in the Late state 220, it is marked as Miss. Transitions between the elements are represented using arrows, with arrows corresponding to the read operation in a bolder line thickness than those transitions corresponding to the write operation.

Initially, all elements are marked as Hit 230. When an element is written by a write process (130 in FIG. 1), it is marked as Ready 210 if the write was successful in transitions 211, 221, 231, or 241 (depending on the initial state). This indicates that the packet is ready to be read by a read process (120 in FIG. 1).

However, it should be noted that if the packets arrive non-sequentially; that is, if a received packet has a sequence number greater than the sequence number of an expected packet (which would typically be one greater than the sequence number of the packet to be received and the last element to be written), at least one element whose index corresponds to a sequence number between that of the received packet and the expected packet will be marked as Late 220. This is shown by transitions 212, 222, 232 and 242.

When the read process (120 in FIG. 1) reads an element that is in the Ready state 210, it will output the data and mark the element as a Hit 230, as shown in transition 213. On other hand, if the read process (120 in FIG. 1) reads an element that is in any other state, it will mark the element as a Miss 240, as shown in transitions 224, 234, and 244. In this case, the contents are not output and instead a PLC packet is output.

Under normal operation (e.g., where neither buffer underruns nor buffer overflows occur), elements should fluctuate between Hit 230 and Ready 210 as they are read and written, respectively. If a network link fails or incoming data is otherwise interrupted, the write operation will stop and eventually all elements will enter the Hit 230 or Miss 240 state. Furthermore, the jitter may be easily estimated by counting the number of elements which are in the Miss state 240 and multiplying by the frame size.

The specific steps described herein for implementing an adaptive jitter buffer in accordance with embodiments of the invention are merely illustrative, and it is to be appreciated that various other steps for performing similar functions are contemplated, as will become apparent to those skilled in the art.

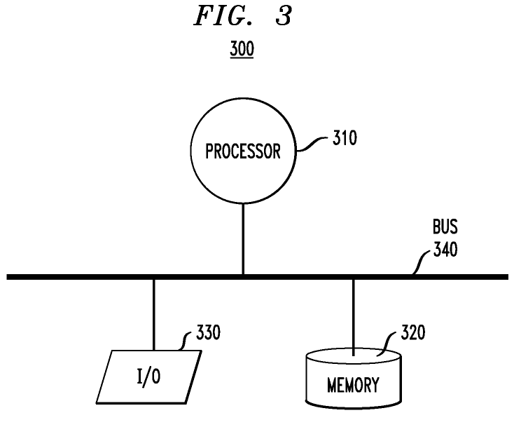

The methodologies of embodiments of the invention may be particularly well-suited for use in an electronic device or alternative system (e.g., VoIP telephony system). For example, FIG. 3 is a block diagram depicting an exemplary processing system 300 formed in accordance with an aspect of the invention. System 300, which may represent, for example, a VoIP communication terminal or endpoint, may include a processor 310, memory 320 coupled to the processor (e.g., via a bus 340 or alternative connection means), as well as input/output (I/O) circuitry 330 operative to interface with the processor. The processor 310 may be configured to perform at least a portion of the methodologies of the present invention, illustrative embodiments of which are shown in the previous figures and described herein above.

It is to be appreciated that the term “processor” as used herein is intended to include any processing device, such as, for example, one that includes a central processing unit (CPU) and/or other processing circuitry (e.g., network processor, digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

Accordingly, an application program, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor. In any case, it is to be appreciated that at least a portion of the components shown in the previous figures may be implemented in various forms of hardware, software, or combinations thereof (e.g., one or more DSPs with associated memory, application-specific integrated circuit(s), functional circuitry, one or more operatively programmed general purpose digital computers with associated memory, etc). Given the teachings of the invention provided herein, one of ordinary skill in the art will be able to contemplate other implementations of the components of the invention.

At least a portion of the illustrative techniques of the present invention may be implemented in an integrated circuit. In forming integrated circuits, die are typically fabricated in a repeated pattern on a surface of a semiconductor wafer. Each of the die includes a device described herein, and may include other structures or circuits. Individual die are cut or diced from the wafer, then packaged as integrated circuits. One skilled in the art would know how to dice wafers and package die to produce integrated circuits. Integrated circuits so manufactured are considered part of this invention.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A jitter buffer having a controllable delay associated therewith, the jitter buffer comprising:
at least one ring buffer including a plurality of storage elements, the ring buffer being configured having independent read and write operations, wherein the delay associated with the jitter buffer is controllable as a function of a number of elements between a first element accessed by the write operation and a second element accessed by the read operation.

2. The buffer of claim 1, wherein the at least one ring buffer comprises a fixed number of storage elements.

3. The buffer of claim 1, wherein the read and write operations are operative to access different storage elements in the at least one ring buffer at any given time.

4. The buffer of claim 1, wherein at least one of the plurality of storage elements in the at least one ring buffer comprises a data array.

5. The buffer of claim 1, wherein a minimum number of storage elements in the at least one ring buffer is determined as a function of a maximum acceptable jitter divided by a size of a data frame to be stored in the at least one ring buffer.

6. The buffer of claim 5, wherein the maximum acceptable jitter is about 150 milliseconds (ms) and the data frame size is about 20 ms.

7. The buffer of claim 1, wherein each of the plurality of storage elements in the ring buffer is associated with a unique index number, each index number being indicative of a corresponding temporal relationship with respect to a packet of data in an input data stream supplied to the ring buffer.

8. The buffer of claim 7, wherein the index numbers are indicative of respective positions of the storage elements within the ring buffer relative to one another.

9. The buffer of claim 7, wherein the index number of a given storage element in the ring buffer is indicative of a sequence number of a data packet stored in the given element modulo a total number of elements in the ring buffer.

10. The buffer of claim 7, wherein at least one of a read operation and a write operation in the ring buffer sequentially accesses a corresponding storage element in order of increasing index number.

11. The buffer of claim 1, wherein each of the plurality of storage elements in the ring buffer is in one of a plurality of logical states at any given time.

12. The buffer of claim 11, wherein the logical state in which a given one of the storage elements resides comprises one of Ready, Late, Hit, and Miss.

13. The buffer of claim 12, wherein a given storage element proceeds to the Ready state upon completion of a successful write operation of the given element.

14. The buffer of claim 12, wherein when a received packet has a sequence number greater than a sequence number of an expected packet, an element in the Ready state whose index number corresponds to a sequence number in a range between that of the received packet and that of the expected packet will proceed to the Late state.

15. The buffer of claim 12, wherein, when the read operation accesses a given element in the Ready state, the given element will proceed to the Hit state upon completion of a successful read of the given element.

16. The buffer of claim 12, wherein, when the read operation accesses a given storage element in one of the Hit state and the Late state, the given element will proceed to the Miss state.

17. The buffer of claim 12, wherein data stored in a given storage element in the ring buffer will be output when the given element is in the Ready state upon completion of a successful read operation of the given element.

18. The buffer of claim 10, wherein an amount of jitter associated with the jitter buffer is substantially equal to a number of elements in the Miss state multiplied by a data frame size.

19. An integrated circuit, comprising at least one jitter buffer as set forth in claim 1.

20. A method of buffering data, comprising the steps of:
writing at least one data packet from an input data stream into a first storage element of a ring buffer including a plurality of storage elements;
reading data from a second storage element of the ring buffer; and
controlling a delay between when the data packet is received from the input data stream and when the data packet is output by the ring buffer by selectively controlling a number of elements by which the second element accessed by the reading step lags behind the first element accessed by the writing step.

21. The method of claim 20, wherein the writing step comprises performing a bucket sort to determine an index number at which at least one storage element is to be written.

22. The method of claim 20, wherein the writing step comprises the step of marking a given element as Ready upon completion of a successful write operation.

23. The method of claim 20, wherein the writing step comprises the step of:
when a received packet has a sequence number greater than a sequence number of an expected packet, marking an element in the Ready state whose index number corresponds to a sequence number in a range between that of the received packet and that of the expected packet as being in a Late state.

24. The method of claim 20, wherein the reading step comprises the step of:
when a given element is marked as Ready, marking the given element as Hit and outputting data stored in the given element.

25. The method of claim 20, wherein the reading step comprises the step of:
when a given element is marked as one of a Hit and Late, marking the given element as a Miss and not outputting data stored in the given element.

26. An article of manufacture comprising a machine-readable storage medium containing one or more software programs that, when executed, perform the steps of:
writing at least one data packet from an input data stream into a first storage element of a ring buffer including a plurality of storage elements;
reading data from a second storage element of the ring buffer; and
controlling a delay between when the data packet is received from the input data stream and when the data packet is output by the ring buffer by selectively controlling a number of elements between the second element accessed by the reading step and the first element accessed by the writing step.

27. A system including at least one jitter buffer having a controllable delay associated therewith, the jitter buffer comprising:
at least one ring buffer including a plurality of storage elements, the ring buffer being configured having independent read and write operations, wherein the delay associated with the jitter buffer is controllable as a function of a number of elements between a first element accessed by the write operation and a second element accessed by the read operation.
